(19) United States
(12) Patent Application Publication
(10) Pub. No.: US 2004/0121637 A1
(43) Pub. Date: Jun. 24, 2004

(54) Socket connecting system for connecting electrical conductors

(76) Inventors: Werner Beege, Hainburg (DE); Hubert Herrmann, Eppertshausen (DE); Werner Radde, Babenhausen (DE); Klaus Steinmetz, Floersheim (DE)

Correspondence Address: Lawrence E. Laubscher, Sr., Suite 300, 745 South 23rd Street, Arlington, VA, 22202-2451, US

(21) Appl. No.: 10/683,356

(22) Filed: Oct. 14, 2003

(30) Foreign Application Priority Data
Oct. 18, 2002 (DE) 202 16 115.3

(51) Int. Cl. H01R 13/52

(52) U.S. Cl. 439/271

(57) ABSTRACT

A plug and socket electrical connector arrangement, in particular, a sensor plug connector system for the connection of electrical conductors, includes plug and socket components that are protected against the penetration of moisture by means of at least one seal device, wherein the electrical plug connector system is designed in the manner of a coupling arrangement for the connection of high-pressure fluid medium conduits.

### CROSS REFERENCE TO RELATED APPLICATIONS

German Application No. 202 16 115.3 filed Oct. 18, 2002.

### FIELD OF THE INVENTION

This invention relates to a plug connector system, especially a sensor plug connector system for the connection of electrical conductors, including a plug component and a socket component, characterized in that, when plugged together, the components are protected against penetration of moisture by means of seals.

### BACKGROUND OF THE INVENTION

It is known that one can design plug connector systems in the form of a sealed module so that they are secured against the penetration of moisture in a certain protection mode. One can, for example, achieve the moisture protection modes IP65 to IP67.

According to the state of the art it is, of course, relatively difficult and expensive to design a plug connector system for the connection of electrical conductors with a high moisture protection mode.

The present invention was developed to provide a favorable possibility for reducing and setting up plug connector systems with a high moisture protection load such as IP65 to IP67.

### DESCRIPTION OF THE RELATED ART

According to the present invention, the plug connector system is fashioned in the manner of pneumatic couplings or plug connector systems for the connection of high-pressure fluid medium conduits. In particular, the plug and socket components are fashioned, in terms of their geometry, preferably with regard to the structural size according to the manner of pneumatic couplings or plug connector systems for the connection of high-pressure fluid medium lines.

The present invention is based on the idea of incorporating in the structure and design in the field of electrical plug and socket connectors the known technology of plug connector systems previously used for the coupling of high pressure fluid medium lines, for example, for connecting the conduits of a pneumatic system. It is well known that pressure medium lines are generally already efficiently sealed. Moreover, they are produced in large numbers. According to the present invention, by utilizing the technology and the basic geometry and the structure of known high-pressure fluid medium coupling systems, one can substantially reduce the cost of a plug connector system for the connection of electrical conductors.

The present invention offers the advantage of using identical parts or the modification of already existing parts from the known high-pressure fluid plug coupling systems, as well as the high degree of functional reliability of the last mentioned arrangement, which have an advantageous effect also with relation to the connection of electrical conductors.

Another advantage consists of analog operating procedure so that the plug connector system is especially suitable where one can jointly combine a pressure medium coupling system and an electrical connector system.

Plug connector or pneumatic coupling systems used in fluid pressure medium engineering are well known in the prior art, as evidenced, for example, by the German Off. No. DE 195 40 559 A1, and the German patents Nos. 197 25 999 C1, DE 38 10 351 C2, and DE 40 39 066 C1, and the U.S. Pat. No. 5,205,594.

### BRIEF SUMMARY OF THE INVENTION

Thus, a primary object of the present inventions to provide an electrical connector those functions in the same manner as a pneumatic coupling system for connecting high-pressure fluid medium lines.

According to another object of the invention, use can be made also of a traction release device for separating the plug and socket components.

Furthermore, the other geometry of the plug connectors can extensively be adapted to the high-pressure fluid medium plug connector system in order to create extensive agreement also regarding the handling of the systems.

According to another object of the invention, in order to prevent erroneous couplings between the two systems, the electrical plug and socket connector system can additionally be provided with mechanical and/or optical coding means for preventing erroneous couplings, for example, of a socket component of the electrical plug system with a plug component of the high pressure fluid medium plug connector system.

According to a preferred embodiment of the invention, the plug component or the socket component is integrally molded upon a supporting device, especially a valve island of the plug connector system for the connection of pressure medium lines. For example, on valve islands of the high-pressure fluid medium art, it is often necessary to provide sensor or actuator lines to operate and/or monitor electrical or mechanical equipment, such as valves or sensors arranged within a fluid-containing receptacle. By directly and integrally molding the part onto the equipment, one can, on the equipment from pressure medium engineering, make use both of the advantage of using identical parts and the advantage of almost identical operation of the two plug systems, in both the electrical connector field and in the high pressure fluid medium field.

### BRIEF DESCRIPTION OF THE DRAWINGS

Other objects and advantages of the present invention will become apparent from a study of the following specification, when viewed in the light of the accompanying drawings, in which:

FIG. 1 is a perspective exploded view illustrating the electrical contacts of the electrical plug and socket connector system;

FIGS. 2 and 3 are perspective views illustrating the plug connector system of FIG. 1 in the disassembled and assembled conditions, respectively;

FIG. 4 is a perspective view of the plug connector system corresponding to FIG. 3, with the socket component partially cut away; and

FIG. 5 is a sectional view of a known pneumatic coupling of the prior art.

### DETAILED DESCRIPTION OF THE INVENTION

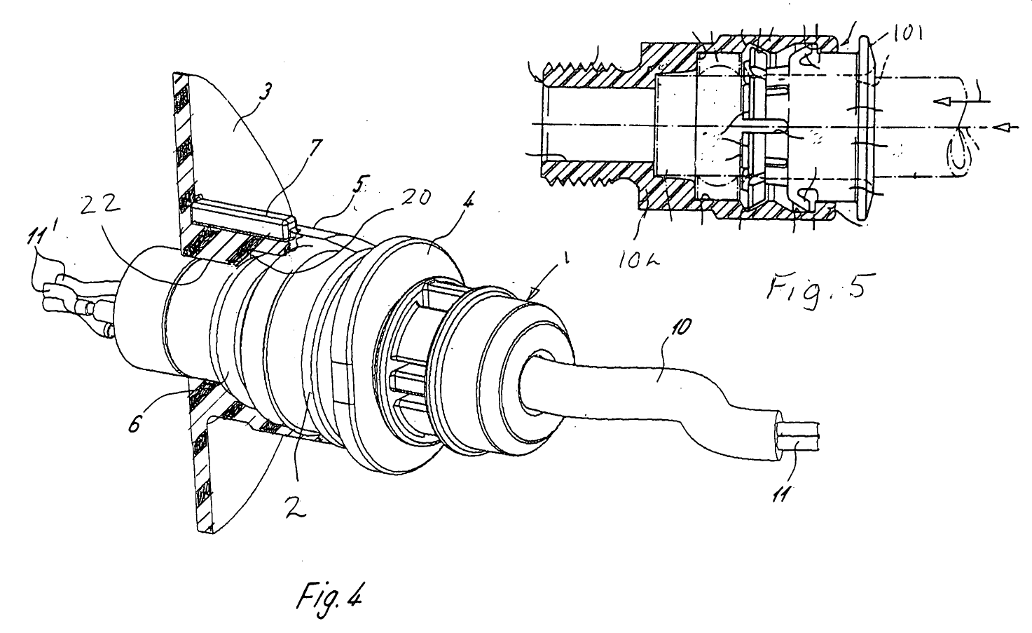

Referring first more particularly to FIG. 5, it is known in the prior art, as evidenced by the aforementioned German patent No. DE 40 42 447 C1, to provide a coupling including a plug 100 and a resilient socket 102 for connecting together a pair of pneumatic conduits in a leak-proof manner. The technology of the design and manufacture of such pneumatic couplings is quite advanced. The present invention was developed to incorporate the known techniques and technology in the electrical connector art.

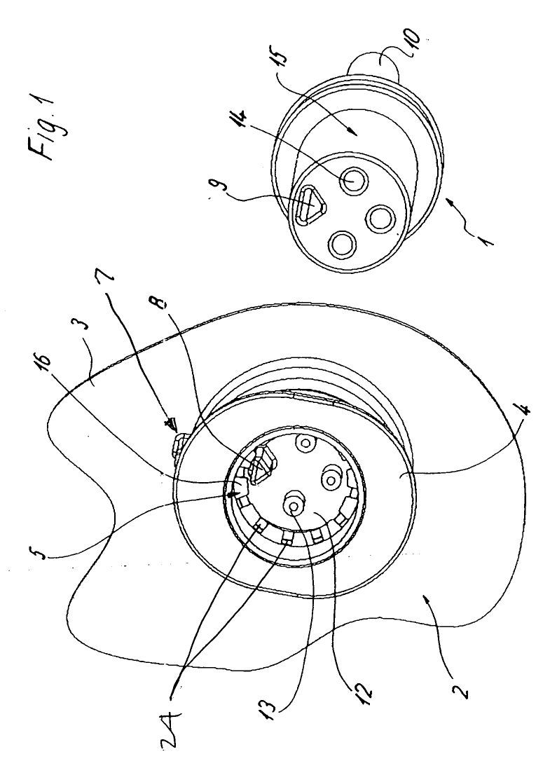

Referring now to FIGS. 1-3, the electrical connector system of the present invention includes a plug connector 1 that is adapted for connection with a female receptacle of socket 2 that is integrally incorporated by injection molding within a support structure 3, such as a so-called sensor valve island, or the portion of the wall of a fluid-containing container. At its forward end, the socket is provided with an annular unlocking flange 4, and at its other end within the chamber 12, the socket is provided with traction release means 5 including an axially displaceable peg 16 that is forwardly displaceable within the chamber 12 to assist in the separation of the plug and socket components. A plurality of spaced stationary pin contacts 13 are carried on the bottom wall of the socket chamber 12 for engagement with corresponding female contacts 14 carried by the bottom wall of the plug body 15.

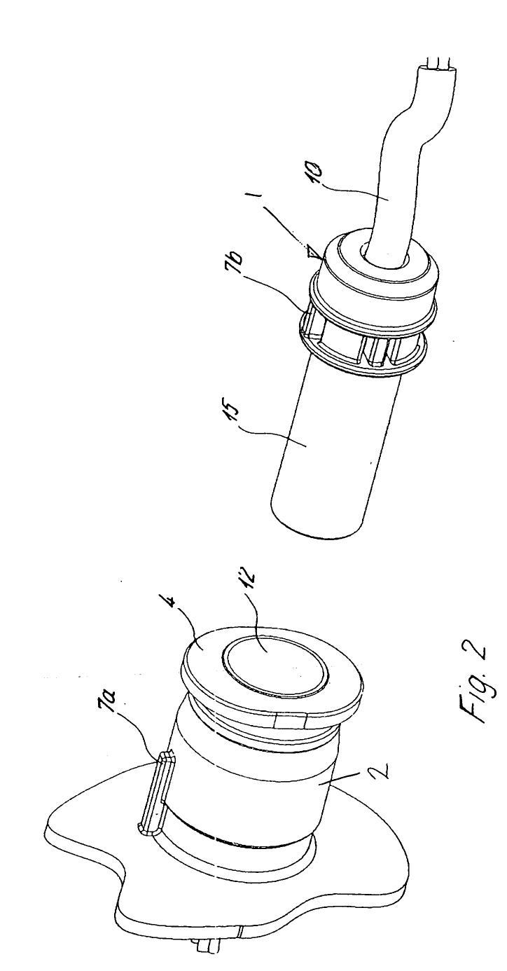

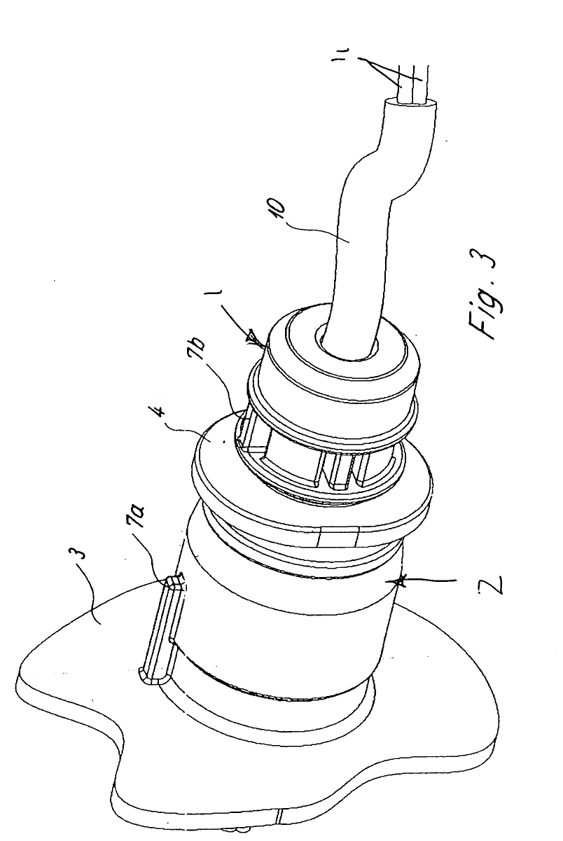

According to an important feature of the invention, a locator or polarizing pin 8 on the socket chamber bottom wall cooperates with a corresponding locator opening 9 contained in the bottom wall of the plug, thereby to assure the appropriate angular orientation between the plug 1 and the socket 2. Also, in order to assure that the plug and socket are related, color coding means 7 are provided including an optical indicator 7a on the socket that corresponds with the optical indicator 7b on the plug. The function of optical coding can be implemented also be differing coloration between the electrical connector system and the high-pressure fluid medium system. For example, the unlocking ring 4 of one system can be color blue and that of the other system can be color red. Thus, when the electrical plug 1 of FIGS. 1 and 2 is inserted within the electrical socket 2 to the assembled condition of FIG. 3, the conductors 11 of cable 10 are electrically connected with the socket conductors 11′ (FIG. 4) via female contacts 14 and male contact pins 13. The socket conductors 11′ may be connected with an electromechanical device (such as a pressure or temperature sensor, or a solenoid valve) contained within the receptacle chamber.

Referring now to FIG. 4, in accordance with a characterizing feature of the invention, seal means in the form of compressed annular seal or washer 6 is provided for sealing the socket component 2 of the plug and socket electrical connector relative to the wall 3 of the valve island. More particularly, the seal 6 is compressed between the shoulder 20 on the wall 3 and the correspond shoulder on the socket 2, thereby to prevent moisture from entering the socket from the receptacle chamber via the wall opening 22 through which the socket extends. Furthermore, resilient radially-extending circumferentially spaced fingers 24 (FIG. 1) are provided at the bottom of the socket chamber 12 for engagement by the corresponding end of the plug component 1, thereby to connect the plug with the socket in moisture-tight sealed relation.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. An electrical plug and socket connector system for connecting a plurality of conductors with a device contained within a fluid-containing receptacle, comprising:
(a) a male electrical plug connector (1) carrying a plurality of first terminals;
(b) a female socket connector (2) adapted for mounting in an opening in the wall portion (3) of the receptacle, said socket connector carrying a plurality of second terminals and containing a chamber (12) for receiving said plug connector, thereby to connect said first and second terminals, respectively; and
(c) seal means (6) for protecting said socket chamber against the penetration of moisture, whereby the connector system is sealed in the manner of a pneumatic coupling.

2. A plug connector system according to claim 1, and further including:
(d) release means (5) contained in said socket chamber for separating a coupled pair of said plug and socket components.

3. A plug connector system according to claim 1, and further including:
(d) optical code means (7) for associating a plug component with a corresponding socket, respectively, thereby to prevent erroneous connection of the components.

4. A plug connector system according to claim 1, characterized in that one of the plug and socket components is molded to form a valve island (3) of the plug connector system for connection with a high-pressure fluid medium line.

5. A plug connector system as defined in claim 1, wherein said socket component is mounted in an opening (22) contained in the wall of the receptacle, said seal means being arranged between a shoulder portion of said socket and a shoulder portion (20) of the wall.
